(19) United States
(12) Patent Application Publication
(10) Pub. No.: US 2021/0185905 A1
(43) Pub. Date: Jun. 24, 2021

(54) ROBOT AND CONTROL METHOD THEREOF

(71) Applicant: LG ELECTRONICS INC., Seoul (KR)

(72) Inventor: Jeongho SEO, Seoul (KR)

(73) Assignee: LG ELECTRONICS INC.

(21) Appl. No.: 17/113,373

(22) Filed: Dec. 7, 2020

(30) Foreign Application Priority Data
Dec. 20, 2019 (KR) 10-2019-0172335

(51) Int. Cl. A01D 34/00; G05D 1/00; G05D 1/02; G06K 9/00; G06K 9/62

(52) U.S. Cl. CPC A01D 34/008; G05D 1/0055; G05D 1/0278; G05D 1/0255; G05D 2201/0208; G05D 1/0246; G06K 9/00362; G06K 9/6215; G05D 1/028

(57) ABSTRACT

The present disclosure provides a robot and a control method thereof. A robot according to the present disclosure includes a rotatable wheel, a cutter configured to cut an external object while the robot is moved by the wheel, a motor configured to rotate the cutter, a transceiver configured to receive GPS information of an external device outside the robot from the electronic device, and a processor configured to rotate the motor, obtain a distance between the robot and an object outside the robot while rotating the motor, and stop the motor based on the distance between the robot and the object. Accordingly, it is possible to protect a user from a danger of a blade and to safely use the robot.

### CROSS-REFERENCE TO RELATED APPLICATION

This application claims priority under 35 U.S.C. § 119 to Korean Application No. 10-2019-0172335 filed on Dec. 20, 2019, whose entire disclosure is hereby incorporated by reference.

### BACKGROUND

### Field

The present disclosure relates to a robot and a control method thereof, and more particularly, to a robot and a control method thereof for performing a preset operation based on a distance between a robot and a surrounding object.

### 2. BACKGROUND

A lawn mower is a device for trimming grass planed in a home yard or a playground. The lawn mower is divided into a household lawn mower and a tractor lawn mower which is used in a wide playground or a wide farm. Meanwhile, the lawn mower mows the lawn using a blade, and thus, the lawn mower has a risk of using the blade.

### BRIEF DESCRIPTION OF THE DRAWINGS

The embodiments will be described in detail with reference to the following drawings in which like reference numerals refer to like elements wherein:

FIG. 1 is a diagram illustrating a robot according to an embodiment of the present disclosure.

FIG. 2 is a flowchart illustrating a control method of a robot according to an embodiment of the present disclosure.

FIG. 3 is a block diagram illustrating configurations of a robot and an external electronic device according to an embodiment of the present disclosure.

FIG. 4 is a flowchart illustrating a method of controlling the robot illustrated in FIG. 3 according to the embodiment of the present disclosure.

FIG. 5 is a diagram illustrating a process of obtaining location information of the external electronic device according to the control method of the robot illustrated in FIG. 4.

FIG. 6 is a diagram illustrating a process of stopping an operation of a driver according to the control method of the robot illustrated in FIG. 4.

FIG. 7 is a block diagram illustrating configurations of a robot and an external electronic device according to an embodiment of the present disclosure.

FIG. 8 is a diagram illustrating a process in which the robot illustrated in FIG. 7 obtains location information of an animal.

FIG. 9 is a diagram illustrating a process of stopping an operation of a driver according to a distance between the animal illustrated in FIG. 7 and the driver.

FIG. 10 is a diagram illustrating a robot and an external electronic device according to another embodiment of the present disclosure.

FIG. 11 is a flowchart illustrating a control method of the robot illustrated in FIG. 10.

FIG. 12 is a diagram illustrating a process of obtaining location information of the external electronic device according to the control method of the robot illustrated in FIG. 11.

FIG. 13 is a diagram illustrating a process of stopping an operation of a driver according to the control method of the robot illustrated in FIG. 11.

FIG. 14 is a diagram illustrating a robot and an external electronic device according to still another embodiment of the present disclosure.

FIG. 15 is a flowchart illustrating a control method of the robot illustrated in FIG. 14.

FIG. 16 is a diagram illustrating a process of obtaining location information of the external electronic device according to the control method of the robot illustrated in FIG. 15.

FIG. 17 is a diagram illustrating a process of stopping an operation of a driver according to the control method of the robot illustrated in FIG. 15.

FIG. 18 is a robot and a moving body according to another embodiment of the present disclosure.

FIG. 19 is a flowchart illustrating a control method of the robot illustrated in FIG. 18.

FIG. 20 is a diagram illustrating a process of obtaining location information of the external electronic device according to the control method of the robot illustrated in FIG. 19.

FIG. 21 is a diagram illustrating a process of stopping an operation of a driver according to the control method of the robot illustrated in FIG. 19.

### DETAILED DESCRIPTION

Hereinafter, embodiments disclosed in the present disclosure will be described in detail with reference to the accompanying drawings, and the same or similar components are denoted by the same reference numerals, and repeated description thereof will be omitted. In descriptions of the embodiments of the present disclosure, when an element is “coupled” or “connected” to another element, it should be understood that a third element may be present between the two elements although the element may be directly coupled or connected to another element.

Moreover, in the descriptions of the embodiments of the present disclosure, if a detailed description of known techniques associated with the present disclosure would unnecessarily obscure the gist of the present disclosure, detailed description thereof will be omitted. In addition, the attached drawings are provided for easy understanding of embodiments of the present disclosure and do not limit technical spirits of the disclosure, and the embodiments should be construed as including all modifications, equivalents, and alternatives falling within the spirit and scope of the present disclosure. Meanwhile, the term “disclosure” may be replaced with terms such as a document, a specification, a description.

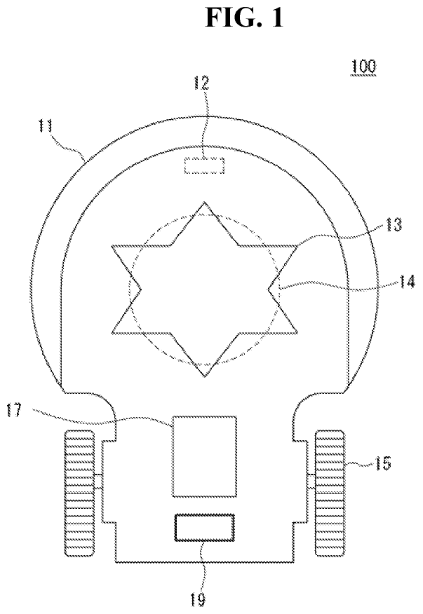

FIG. 1 is a robot 100 according to an embodiment of the present disclosure. As illustrated in FIG. 1, the robot 100 according to the embodiment of the present disclosure may include a protector (or shield) 11, a sensing unit (or sensor) 12, a cutter (or blade) 13, a motor 14, wheels 15, a processor 17, and an interface 19.

The protector 11 prevents the cutter 13 from being separated or discharged from the motor 14 due to a malfunction of the cutter 13. The sensing unit 12 may sense a distance from a surrounding object moved around the robot 100. In addition, the sensing unit 12 may detect location information of the robot 100 itself. For example, the location information of the robot itself may include GPS signal information.

The motor 14 may be coupled to the cutter 13. While the cutter 13 is rotated by a rotation of the motor, the cutter 13 may cut an external cutting object (for example, lawn). Here, the cutter 13 may be in the form of a blade. For example, the cutter 13 may have a blade shape having six corners as illustrated in FIG. 1, but is not necessarily limited thereto.

The interface 19 may obtain a user's input from the outside, and may transmit a signal associated with the obtained user's input to the processor 17. In addition, the interface 19 may output a user interface (UI) for selecting an operation mode of the robot according to the control of the processor 17.

The processor 17 may control at least one of the sensing unit 12, the cutter 13, the motor 14, the wheels 15, and the interface 19 described above. For example, the processor 17 may drive the wheels 15 to move the robot 100. For example, the processor 17 may control the operation of the motor 14 and/or the cutter 13 based on location information of the surrounding object and/or distance information of the surrounding object. That is, when the surrounding object is moved within a predetermined distance from the robot 100, the processor 17 may stop the operation of the motor 14.

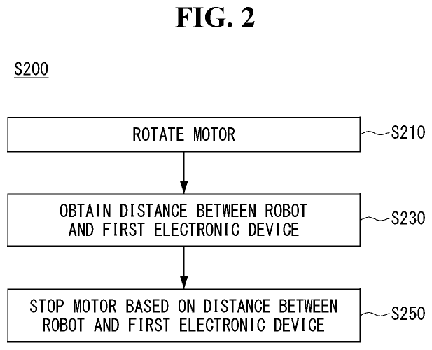

FIG. 2 is a flowchart illustrating a control method of a robot according to an embodiment of the present disclosure. As illustrated in FIG. 2, a robot (for example, the robot 100 of FIG. 1) according to an embodiment of the present disclosure may performs Steps S210 to S250 to control the robot, and detailed descriptions are as follows.

First, the robot rotates the motor provided in the robot (S210). Specifically, the robot may rotate/drive the motor provided in the robot and the cutter coupled to the motor.

Subsequently, the robot may obtain a distance between the robot and a first electronic device (surrounding object). For example, the first electronic device may be one example of a surrounding object having a form of an electronic device moving around the robot. For example, the first electronic device may receive a GPS signal and transmit the GPS signal (location information) of the first electronic device to the robot using a transceiver provided in the first electronic device. That is, the robot obtains the GPS information (location information) of the first electronic device, obtains the GPS signal (location information) of the robot, and obtains a distance between the first electronic device and the robot using the GPS signal of the first electronic device and the GPS signal of the robot.

Next, the robot stops the motor based on the distance between the first electronic device and the robot (S250). For example, when the first electronic device is moved or the robot is moved and the distance between the first electronic device and the robot is within a preset distance, the robot may stop the rotation of the motor which is being driven.

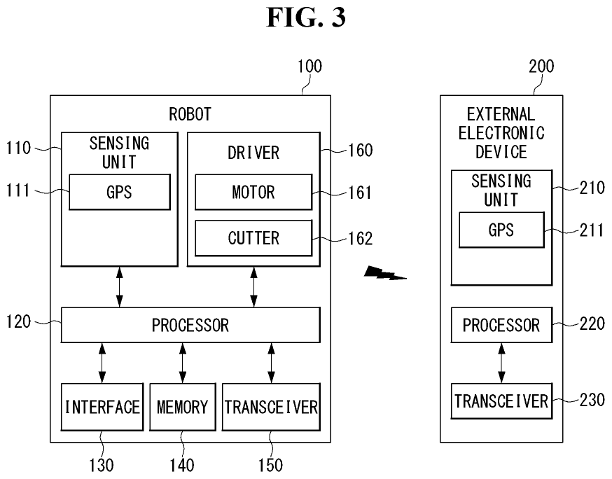

FIG. 3 is a block diagram illustrating configurations of a robot and an external electronic device according to an embodiment of the present disclosure. As illustrated in FIG. 3, according to the embodiment of the present disclosure, the robot 100 may include a sensing unit 110, a drive 160, a processor 120, an interface 130, a memory 140, and a transceiver 150.

Here, the sensing unit 110 may include the sensing unit 12 described with reference to FIG. 1. In addition, the driver 160 may include at least one of the motor 14 and the cutter 13 described with reference to FIG. 1. The processor 120 may include the processor 17 described with reference to FIG. 1. Here, the interface 130 may include the interface 19 described with reference to FIG. 1. In addition, the transceiver 150 may be a portion of the processor 17 described with reference to FIG. 1.

The sensing unit 110 may include at least one sensor. For example, the sensing unit 110 may include a global positioning signal (GPS) sensor 111 for obtaining the location information of the robot. In addition, the sensing unit 110 may include not only the GPS but also all types of sensors for detecting the location of the robot, and is not necessarily limited to the GPS. Moreover, the sensing unit may include various types of sensors for detecting the distance between the external electronic device and the robot, and this will be described in detail later. It should be appreciated that other types of locations signals may be used by the sensing unit 110, such as to receive and evaluate attributes (e.g., a strength) of a communications, networking, or other signals from a base station or the electronic device 300

The driver 160 may include a motor 161 and a cutter 162. The motor 161 may include the motor 14 described with reference to FIG. 1, and the cutter 162 may include the cutter 13 described with reference to FIG. 1.

The interface 130 may include a touch screen (not illustrated) for providing a UI while obtaining a user's input. In addition, the present disclosure is not necessarily limited thereto, and the interface may include all types of interfaces for obtaining a user's input and outputting the UI.

The memory 140 may store information associated with an operation mode of the driver 160 based on the control of the processor 120. For example, when the external electronic device 200 moves within a range in which the distance between the robot 100 and the external electronic device 200 is within a preset distance, while he processor 120 stops an operation of the driver 160 which is being driven, the processor 120 may store information associated with a most recent driving mode (or driving set) of the driver just before stopping in the memory 140. In addition, the memory 140 may store a preset reference value of the distance between the external electronic device 200 and the robot 100. The preset distance value between the external electronic device 200 and the robot 100 may be input by the user through the interface 130 or may be set at the time of manufacture by the manufacturer.

The transceiver 150 may obtain a GPS signal (or other location information) of the external electronic device from the external electronic device 200 based on the control of the processor 120. For example, the transceiver 150 may include at least one of a receiver for receiving data from the outside and a transmitter for transmitting data to the outside. For example, the transceiver 150 may include a transceiver for transmitting and receiving data with the external electronic device 200.

The external electronic device 200 may include a sensing unit 210 which includes a GPS 211. The processor 220 included in the external electronic device may transmit the GPS signal of the external electronic device detected by the GPS 211 to the robot 100 through the transceiver 230.

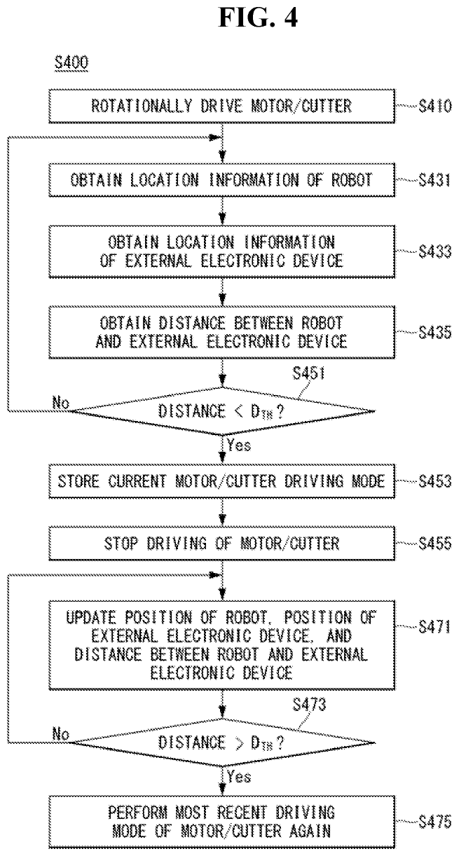

FIG. 4 is a flowchart illustrating a method of controlling the robot illustrated in FIG. 3 according to the embodiment of the present disclosure. As illustrated in FIG. 4, according to an embodiment of the present discloser, the processor of the robot may perform Steps S410 to S475 to control the robot, and the detailed description is as follows.

First, the processor of the robot may rotationally drive the motor and/or the cutter (S410). Subsequently, the processor may obtain location information of the robot (S431). For example, the processor may obtain the location information of the robot using a GPS signal detected by the GPS of the robot.

Next, the processor may obtain the location information of the electronic device outside the robot, from the external electronic device (S433). For example, the processor may obtain the location information of the external electronic device using the GPS signal of the external electronic device transmitted from the external electronic device.

Subsequently, the processor may obtain the distance between the robot and the external electronic device (S435). For example, the processor may obtain the distance between the robot and the external electronic device using the location information of the robot and the location information of the external electronic device.

Next, the processor may determine whether or not the distance between the robot and the external electronic device is smaller than a preset threshold value (DTH) (S451). As a result of the determination, when the distance between the robot and the external electronic device is not smaller than the preset threshold value DTH, the processor performs Steps S431 to S435 again. As the result of the determination, when the distance between the robot and the external electronic device is smaller than the preset threshold value DTH, the processor may store the driving mode of the currently driven motor/cutter (driver) in the memory (S453).

Subsequently, the processor may stop the driving of the motor/cutter (driver) (S455). In a state in which the driving of the motor/cutter (driver) is stopped, the processor may update the location of the robot, the location of the external electronic device, and the distance between the robot and the external electronic device in real time (S471).

Subsequently, the processor may determine whether or not the distance between the robot and the external electronic device is greater than a preset threshold value DTH (S473). As a result of the determination, when the distance between the robot and the external electronic device is not greater than the preset threshold value DTH, the processor performs Step S471 again. As the result of the determination, when the distance between the robot and the external electronic device is greater than the preset threshold value DTH, the processor may perform the most recent driving mode of the motor/cutter (driver) again.

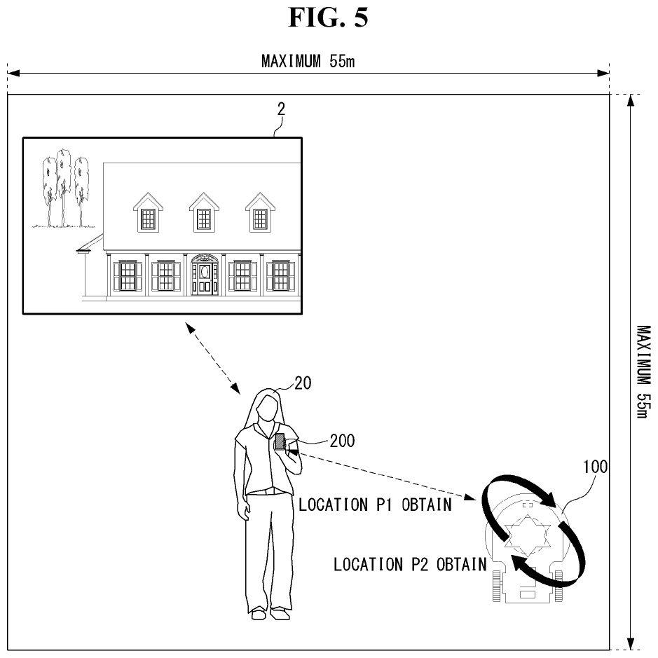

FIG. 5 is a diagram illustrating a process of obtaining the location information of the external electronic device according to the control method of the robot illustrated in FIG. 4. As illustrated in FIG. 5, when a user 20 carrying the external electronic device 200 exits from an indoor 2 to an outdoor space, the external electronic device 200 starts to receive a GPS signal.

When the external electronic device 200 starts to receive the GPS signal, the external electronic device 200 may transmit information associated with the GPS signal of the external electronic device to the robot 100 in operation. The robot 100 may obtain a location information P1 of the external electronic device using the GPS signal of the external electronic device. In addition, the robot 100 may obtain the GPS signal of the robot using the GPS in the robot, and obtain a location information P2 of the robot using the GPS signal of the robot.

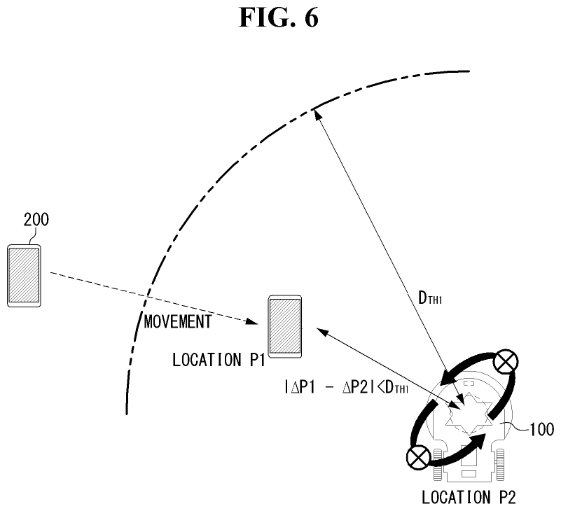

FIG. 6 is a diagram illustrating a process of stopping the operation of the driver according to the control method of the robot illustrated in FIG. 4. As illustrated in FIG. 6, the robot may check that the external electronic device 200 moves and a distance between the external electronic device 200 and the robot 100 is smaller than a threshold value DTH1. Accordingly, when the distance between the robot 100 and the external electronic device 200 is smaller than the threshold value DTH1, the robot may stop the operation of the driver which is being driven.

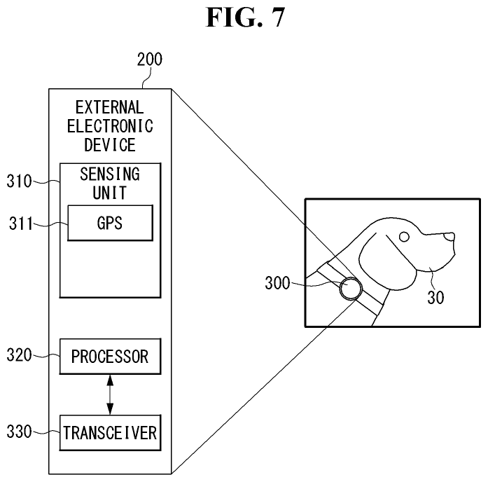

FIG. 7 is a block diagram illustrating configurations of a robot and an external electronic device according to an embodiment of the present disclosure. As illustrated in FIG. 7, according to an embodiment of the present disclosure, the external electronic device 300 may be to be worn on a portion (that is, a neck) of a body of an animal 30.

The external electronic device 300 may include a sensing unit 310 which includes a GPS 311. The GPS 311 may receive the GPS signal of the external electronic device which is worn on the animal 30, and the received GPS signal may be transmitted to a processor 320 of the external electronic device. The processor 320 included in the external electronic device may transmit the GPS signal of the external electronic device detected by the GPS 311 to the robot 100 through the transceiver 330.

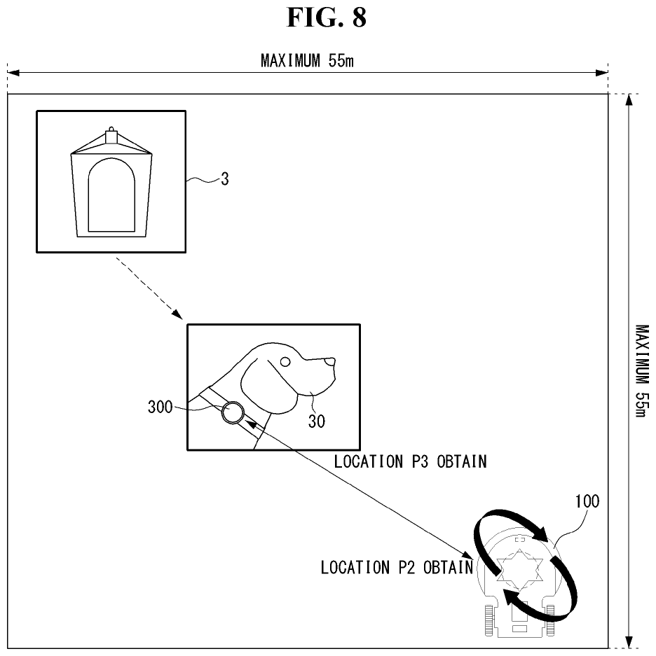

FIG. 8 is a diagram illustrating a process in which the robot illustrated in FIG. 7 obtains location information of the animal. As illustrated in FIG. 8, when the animal 30 wearing the external electronic device 300 exits from an inside 3 to an outside space, the external electronic device 300 starts to receive a GPS signal. If the external electronic device 300 starts to receive the GPS signal, the external electronic device 300 may transmit the GPS signal of the external electronic device to the robot 100 in operation.

The robot 100 may obtain a location information P3 of the external electronic device using the GPS signal of the external electronic device. In addition, the robot 100 may obtain the GPS signal of the robot using the GPS in the robot, and obtain the location P2 of the robot using the GPS signal of the robot.

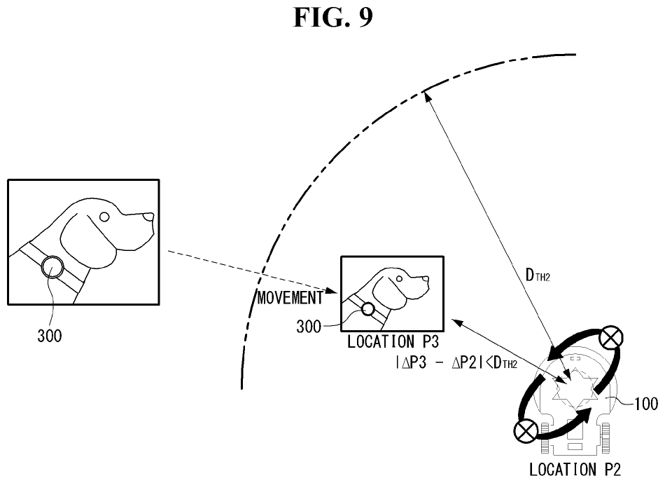

FIG. 9 is a diagram illustrating a process of stopping an operation of the driver according to a distance between the animal illustrated in FIG. 7 and the driver. As illustrated in FIG. 9, the robot may determine that the external electronic device 300 worn by the animal is moved and the distance between the robot 100 and the external electronic device 300 is smaller than the threshold value DTH2. In this way, when the distance between the robot 100 and the external electronic device 300 is smaller than the threshold value DTH2, the robot may stop the operation of the driver which is being driven.

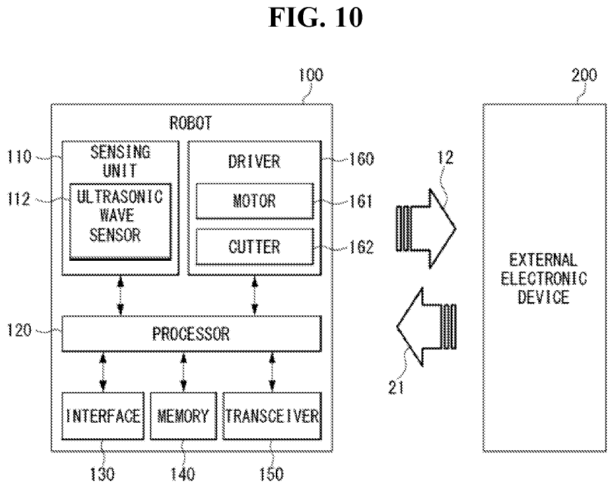

FIG. 10 is a diagram illustrating a robot and an external electronic device according to another embodiment of the present disclosure. As illustrated in FIG. 10, according to another embodiment of the present disclosure, the robot 100 may include the sensing unit 110 having an ultrasonic wave sensor 112. The ultrasonic wave sensor 112 may emit ultrasonic wave 12 toward an external electronic device 200, obtain a reflective ultrasonic wave 21 for the emitted ultrasonic wave (e.g., from the user 20 animal 30), and transmit information associated with arrival times of the emitted ultrasonic wave and the reflected ultrasonic wave to the processor 120. An operation of the driver 160 is the same as described with reference to FIG. 3, and thus, descriptions of the operation are omitted.

The processor 120 may obtain the distance between the external electronic device 200 and the robot 100 based on the information associated with the arrival times of the emitted ultrasonic wave and the reflected ultrasonic wave transmitted from the ultrasonic wave sensor 112. Operations of the interface 130 and the memory 140 are the same as described with reference to FIG. 3, and thus, descriptions of the operations are omitted. The transceiver 150 may perform data communication with the external electronic device 200.

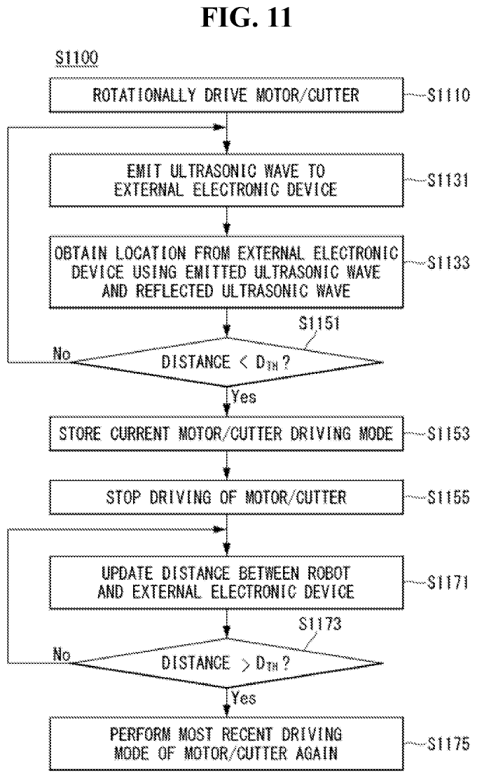

FIG. 11 is a flowchart illustrating a control method of the robot illustrated in FIG. 10. As illustrated in FIG. 11, first, the processor of the robot may rotationally drive the motor/cutter (driver) (S1110). Subsequently, the processor may emit an ultrasonic wave to an external electronic device using an ultrasonic wave sensor (S1131).

Next, the processor may obtain the distance between the external electronic device and the robot using the emitted ultrasonic wave and the reflected ultrasonic wave (S1133). Subsequently, the processor may determine whether or not the distance between the external electronic device and the robot is smaller than the threshold value DTH (S1151). As a result of the determination, when the distance between the robot and the external electronic device is not smaller than the preset threshold value DTH, the processor performs Steps S1131 to S1133 again.

As the result of the determination, when the distance between the robot and the external electronic device is smaller than the preset threshold value DTH, the processor may store the driving mode of the current driving motor/cutter (driver) in the memory (S1153). Subsequently, the processor may stop the driving of the motor/cutter (driver) (S1155).

Next, the processor updates the location of the robot, the location of the external electronic device, and the distance between the robot and the external electronic device in real time (S1171). Subsequently, the processor may determine whether or not the distance between the robot and the external electronic device is greater than the preset threshold value DTH (S1173).

As a result of the determination, when the distance between the robot and the external electronic device is not greater than the preset threshold value DTH, the processor performs Step S1171 again. As the result of the determination, when the distance between the robot and the external electronic device is greater than the preset threshold value DTH, the processor may perform the most recent driving mode of the motor/cutter (driver) again.

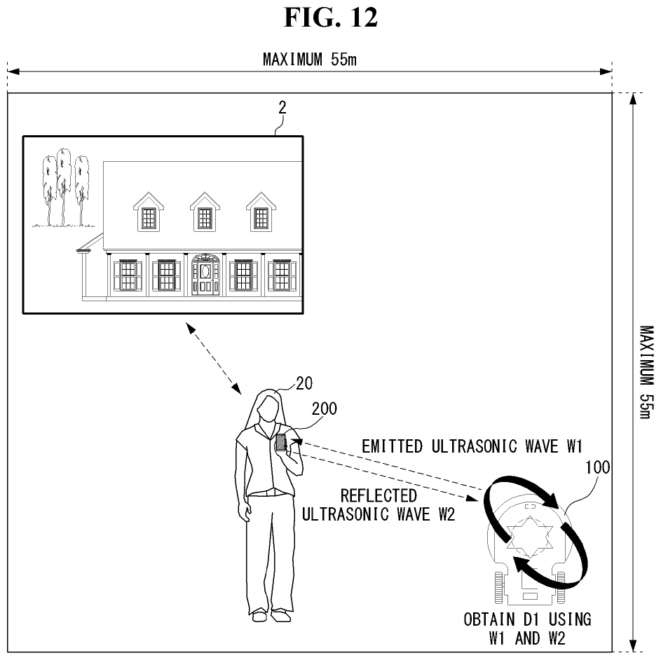

FIG. 12 is a diagram illustrating a process of obtaining the location information of the external electronic device according to the control method of the robot illustrated in FIG. 11. As illustrated in FIG. 12, when the user 20 carrying the external electronic device 200 exits from the indoor 2 to an outdoor space, the robot may emit ultrasonic wave W1 to the external electronic device. Subsequently, the robot 100 may obtain ultrasonic wave W2 that is reflected in response to the emitted ultrasonic wave. The processor of the robot 100 may obtain distance information D1 between the external electronic device 200 and the robot 100 using arrival times of the emitted ultrasonic wave and the reflected ultrasonic wave.

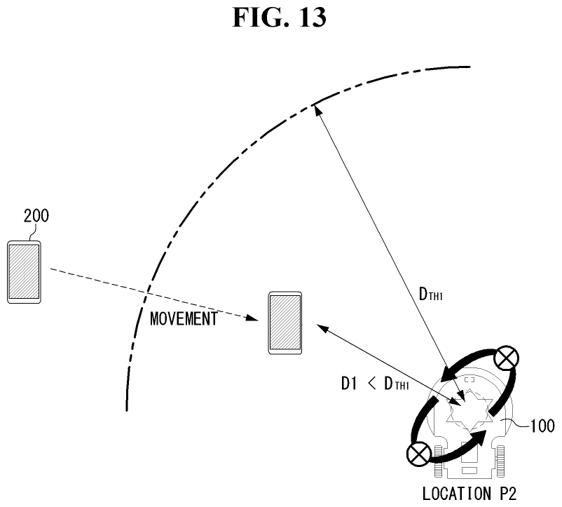

FIG. 13 is a diagram illustrating a process of stopping the operation of the driver according to the control method of the robot illustrated in FIG. 11. As illustrated in FIG. 13, the robot may check that the external electronic device 200 moves and the distance between the external electronic device 200 and the robot 100 is smaller than the threshold value DTH1. Accordingly, when the distance between the robot 100 and the external electronic device 200 is smaller than the threshold value DTH1, the robot may stop the operation of the driver (motor/cuter) which is being driven.

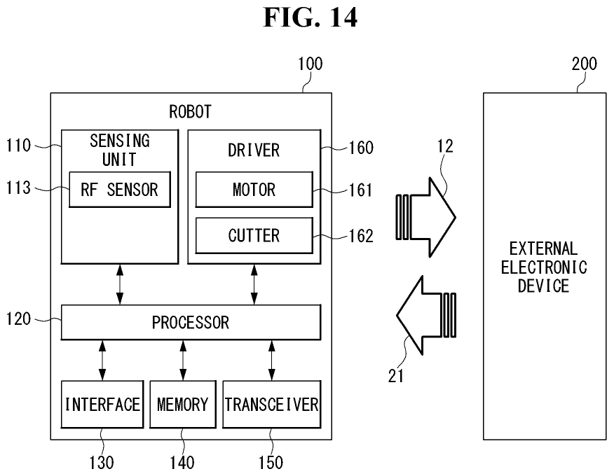

FIG. 14 is a diagram illustrating a robot and an external electronic device according to still another embodiment of the present disclosure. As illustrated in FIG. 14, according to still another embodiment of the present disclosure, the robot 100 may include the sensing unit 110 having an RF sensor 113. The RF sensor 113 may emit an RF signal 12 toward the external electronic device 200 and obtain the reflective RF 21 corresponding to the emitted RF signal (e.g., a reflection from the user 20 or the animal 30). Here, the processor may transmit information associated with arrival times of the emitted RF signal and the reflected RF signal to the processor 120.

The processor 120 may obtain the distance between the external electronic device 200 and the robot 100 based on the information associated with the arrival times of the emitted RF signal and the reflected RF signal transmitted from the sensing unit 110. Operations of the drive, the interface 130, and the memory 140 are the same as described with reference to FIG. 3, and thus, descriptions of the operations are omitted. The transceiver 150 may perform data communication with the external electronic device 200.

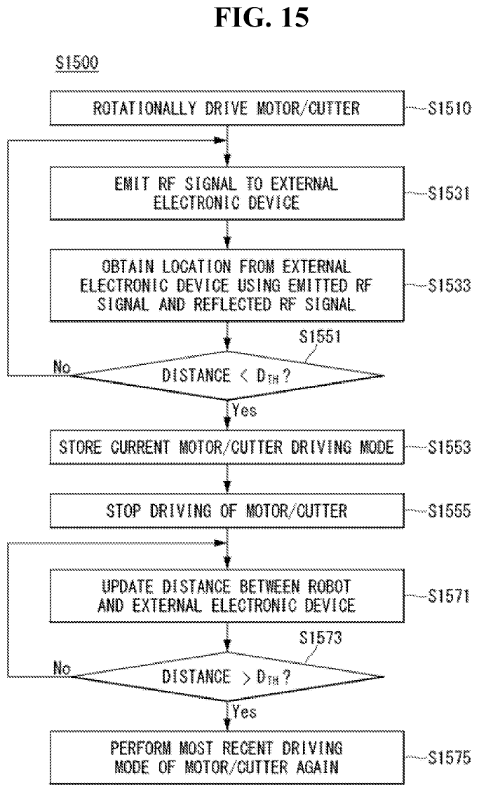

FIG. 15 is a flowchart illustrating a control method of the robot illustrated in FIG. 14. As illustrated in FIG. 15, first, the processor of the robot may rotationally drive the motor/cutter (driver) (S1510). Subsequently, the processor may emit the RF signal to the external electronic device using the RF sensor (S1531). Next, the processor may obtain the distance between the external electronic device and the robot using the emitted RF signal and the reflected RF signal (S1533).

Subsequently, the processor may determine whether or not the distance between the external electronic device and the robot is smaller than the threshold value DTH (S1551). As a result of the determination, when the distance between the robot and the external electronic device is not smaller than the preset threshold value DTH, the processor performs Steps S1531 to S1533 again. As the result of the determination, when the distance between the robot and the external electronic device is smaller than the preset threshold value DTH, the processor may store the driving mode of the current driving motor/cutter (driver) in the memory (S1553). Subsequently, the processor may stop the driving of the motor/cutter (driver) (S1555).

Next, the processor updates the location of the robot, the location of the external electronic device, and the distance between the robot and the external electronic device in real time (S1571). Subsequently, the processor may determine whether or not the distance between the robot and the external electronic device is greater than a preset threshold value DTH (S1573).

As a result of the determination, when the distance between the robot and the external electronic device is not greater than the preset threshold value DTH, the processor performs Step S1571 again. As the result of the determination, when the distance between the robot and the external electronic device is greater than the preset threshold value DTH, the processor may perform the most recent driving mode of the motor/cutter (driver) again (S1575).

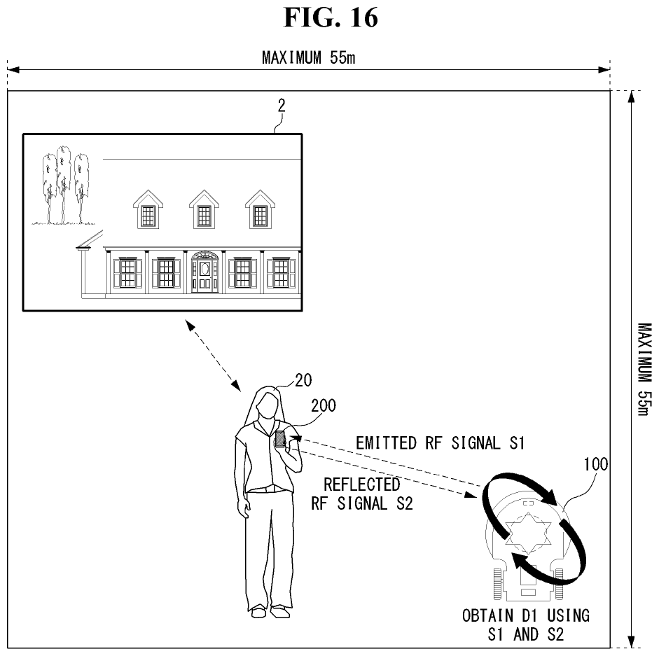

FIG. 16 is a diagram illustrating a process of obtaining the location information of the external electronic device according to the control method of the robot illustrated in FIG. 15. As illustrated in FIG. 16, when the user 20 carrying the external electronic device 200 exits from the indoor 2 to the outdoor space, the robot 100 may emit an RF signal 51 to the external electronic device.

Subsequently, the robot 100 may obtain an RF signal S2 reflected in response to the emitted RF signal. The processor of the robot 100 may obtain a distance D1 between the external electronic device 200 and the robot 100 using arrival times of the emitted RF signal 51 and the reflected RF signal S2.

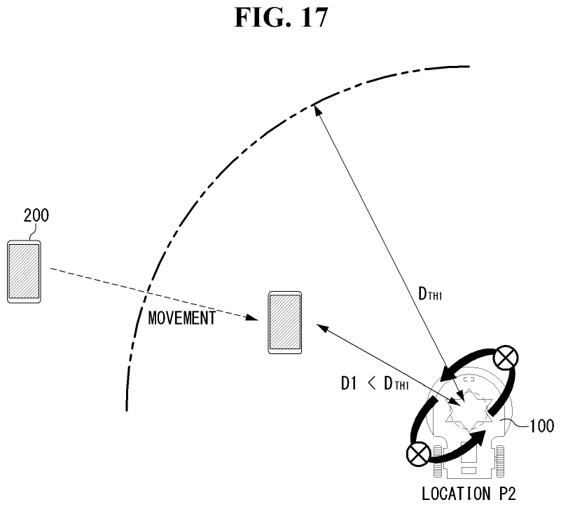

FIG. 17 is a diagram illustrating a process of stopping the operation of the driver according to the control method of the robot illustrated in FIG. 15. As illustrated in FIG. 17, the robot may check that the external electronic device 200 moves and the distance between the external electronic device 200 and the robot 100 is smaller than the threshold value DTH1. Accordingly, when the distance between the robot 100 and the external electronic device 200 is smaller than the threshold value DTH1, the robot may stop the operation of the driver (motor/cutter) which is being driven.

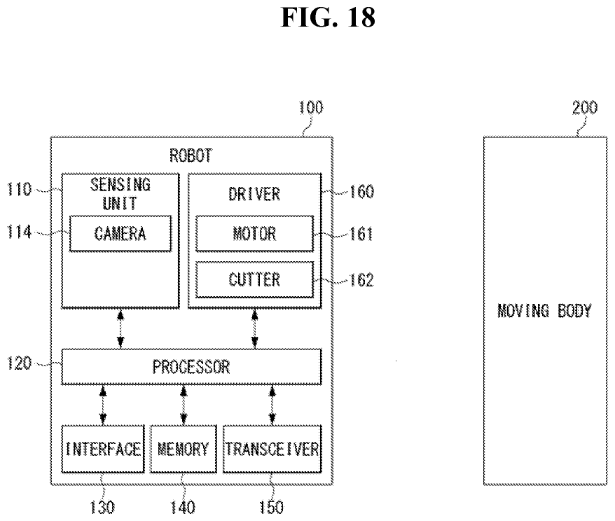

FIG. 18 is a robot and a moving body according to another embodiment of the present disclosure. As illustrated in FIG. 18, according to another embodiment of the present disclosure, the robot 100 may include a sensing unit 110 having a camera 114. The camera 114 may photograph an external image including a moving body 200 and transmit the photographed external image to the processor 120.

The processor 120 may obtain the distance between the external electronic device 200 and the robot 100 based on the external image transmitted from the sensing unit 110. For example, the processor may determine the distance between the moving body and the robot included in the external image through an image processing analysis technique for the external image.

Operations of the drive, the interface 130, and the memory 140 are the same as described with reference to FIG. 3, and thus, descriptions of the operations are omitted. The transceiver 150 may perform data communication with the moving body 200.

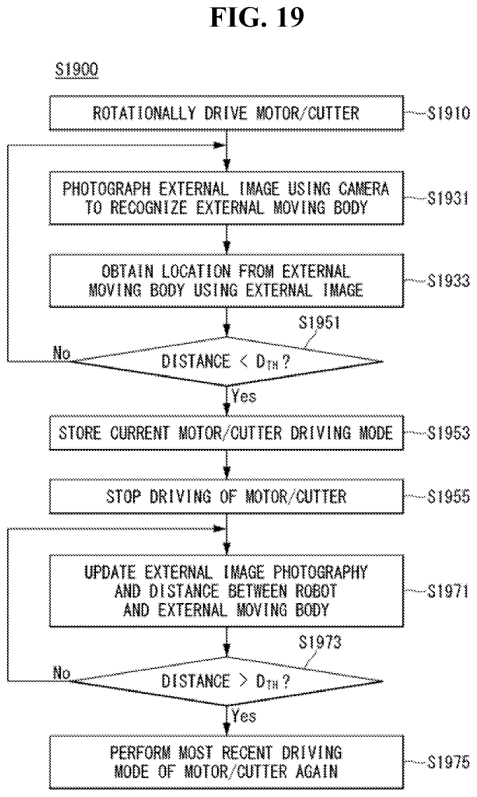

FIG. 19 is a flowchart illustrating a control method of the robot illustrated in FIG. 18. As illustrated in FIG. 19, first, the processor of the robot may rotationally drive the motor/cutter (driver) (S1910). Subsequently, the processor may photograph the external image using the camera of the robot to recognize the moving body (S1931). Next, the processor may obtain the distance between the external moving body and the robot using the external image photographing the moving body (S1933).

Subsequently, the processor may determine whether or not the distance between the external electronic device and the robot is smaller than the threshold value DTH (S1951). As a result of the determination, when the distance between the robot and the external electronic device is not smaller than the preset threshold value DTH, the processor performs Steps S1931 to S1933 again.

As the result of the determination, when the distance between the robot and the external electronic device is smaller than the preset threshold value DTH, the processor may store the driving mode of the current driving motor/cutter (driver) in the memory (S1953). Subsequently, the processor may stop the driving of the motor/cutter (driver) (S1155).

Next, the processor photographs the external image every preset period and updates the distance between the robot and the external moving body using the photographed image (S1971). Subsequently, the processor may determine whether or not the distance between the robot and the external electronic device is greater than a preset threshold value DTH (S1973).

As a result of the determination, when the distance between the robot and the external electronic device is not greater than the preset threshold value DTH, the processor performs Step S1971 again. As the result of the determination, when the distance between the robot and the external electronic device is greater than the preset threshold value DTH, the processor may perform the most recent driving mode of the motor/cutter (driver) again (S1975).

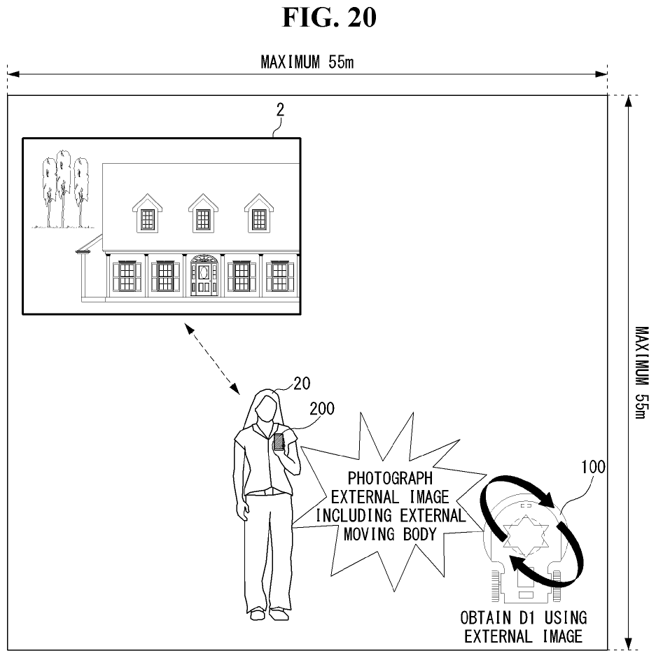

FIG. 20 is a diagram illustrating a process of obtaining location information of the external electronic device according to the control method of the robot illustrated in FIG. 19. As illustrated in FIG. 20, when the moving body (person) 200 exits from the indoor 2 to the outdoor space, the robot 100 may photograph the external image including the external moving body. Subsequently, the processor may analyze the external image through an image processing technique and obtain the distance D1 between the external moving body and the robot in the external image based on the analysis result.

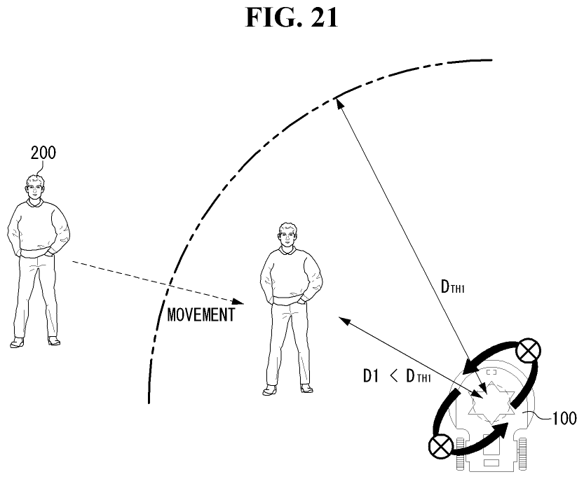

FIG. 21 is a diagram illustrating a process of stopping an operation of a driver according to the control method of the robot illustrated in FIG. 19. As illustrated in FIG. 21, the robot may check that the external moving body 200 moves and the distance between the external moving body 200 and the robot 100 is smaller than the threshold value DTH1. Accordingly, when the distance between the robot 100 and the external electronic device 200 is smaller than the threshold value DTH1, the robot may stop the operation of the driver (motor/cutter) which is being driven.

Certain embodiments or other embodiments of the present disclosure described above are not mutually exclusive or distinct from one another. Respective configurations or functions of certain embodiments or other embodiments of the present disclosure described above can be used together or combined with each other.

For example, it is understood that an A configuration described in certain embodiments and/or drawings and a B configuration described in other embodiments and/or drawings may be combined with each other. That is, even when a combination between configurations is not described directly, it means that the combination is possible except when it is described that the combination is impossible. For example, the robot 100 may include two or more of the GPS sensor 111, ultrasonic wave sensor 112, RF sensor 113, and/or camera 114 and may determine a distance between the robot 100 and the user 20 or animal 30 based on results from one or more of the sensors 111-114. In another example, the robot 100 may initially determining a distance between the robot 100 and user 20 or animal 30 using one of the sensors 111-114 (e.g., GPS 111), and may subsequently determine a change in the distance using another one of the sensors 111-114.

The foregoing detailed description should not be construed as limiting in all aspects, but should be considered as illustrative. The scope of the present disclosure should be determined by reasonable interpretation of the appended claims, and all changes within the equivalent scope of the present disclosure are included in the scope of the present disclosure.

According to the robot and the control method thereof according to the present disclosure, an active access recognition function for the surrounding object is realized so as to control the motor for driving the blade cutting the lawn or control the operation of the set. Accordingly, it is possible to prevent the user from the danger of the blade and to safely use the robot.

Moreover, according to at least one of the embodiments of the present disclosure, the user directly selects a recognition distance from the surrounding object and the operation mode using the existing sensor without adding a separate sensor in the robot so as to use the robot, and thus, it is possible to use a function suitable for a customer's situation.

The present disclosure provides a robot and a control method thereof capable of protecting a surrounding object from a blade when a surrounding object approaches the robot having a blade. In an aspect, there is provided a method of controlling a robot including: rotating a motor; obtaining GPS information of an electronic device outside the robot from the robot and the electronic device while rotating the motor; obtaining a distance between the robot and the electronic device using the GPS information of the electronic device; and stopping the motor based on the distance between the electronic device and the robot. The stopping of the motor may include stopping the motor when the distance between the robot and the electronic device is within a preset threshold value.

The method may further include: obtaining GPS information of the robot, in which the obtaining of the distance between the robot and the electronic device may include using the GPS information of the electronic device and the GPS information of the robot. The obtaining of the distance between the robot and the electronic device may include using a first ultrasonic wave emitted from the electronic device and a second ultrasonic wave which is reflected in response to the first ultrasonic wave.

The obtaining of the distance between the robot and the electronic device may include using an emission RF signal emitted from the electronic device and a reflective RF signal associated with the emission RF signal. The obtaining of the distance between the robot and the electronic device may include photographing the electronic device, analyzing an external image obtained by photographing the electronic device, and calculating the distance between the robot and the electronic device based on an analysis result.

The rotating of the motor may include driving the motor in a first mode. Moreover, after the stopping of the motor, the method may further include: updating the distance between the robot and the electronic device; and driving the motor in the first mode when the distance between the robot and the electronic device is the threshold value or more.

In another aspect, there is provided a robot configured to move in an outside space, the robot including: a rotatable wheel; a cutter configured to cut an external object while the robot is moved by the wheel; a motor configured to rotate the cutter; a transceiver configured to receive GPS information of an external device outside the robot from the electronic device; and a processor configured to rotate the motor, obtain a distance between the robot and the electronic device using the GPS information of the electronic device obtained from the transceiver while rotating the motor, and stop the motor based on the distance between the robot and the electronic device.

The processor may stop the motor when the distance between the robot and the electronic device is within a preset threshold value. The robot may further include: a sensor configured to detect the GPS information of the robot, in which the processor may obtain the distance between the robot and the electronic device using the GPS information of the electronic device and the GPS information of the robot.

The processor may obtain the distance between the robot and the electronic device outside the robot using a first ultrasonic wave emitted from the electronic device and a second ultrasonic wave reflected in response to the first ultrasonic wave. The processor may obtain the distance between the robot and the electronic device outside the robot using an emission RF signal emitted from the electronic device and a reflective RF signal associated with the emission RF signal.

The robot of claim may further include: a camera, in which the processor may photograph the electronic device using the camera, analyze an external image obtained by photographing the electronic device, and calculate the distance between the robot and the electronic device based on an analysis result.

The processor may drive the motor in a first mode, update the distance between the robot and the electronic device after stopping the motor, and drive the motor in the first mode when the distance between the robot and the electronic device is the threshold value or more.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling a robot, the method comprising:
rotating a cutting blade of the robot;
determining a distance between the robot and a person or an animal; and
changing a rotational speed of the cutting blade based on the distance between the robot and the person or the animal.

2. The method of claim 1, wherein changing the rotational speed of the cutting blade includes deactivating a motor driving the cutting blade when the distance between the robot and the person or the animal is within a threshold value.

3. The method of claim 1, wherein determining the distance between the robot and the person or the animal includes:
obtaining global positioning system (GPS) information of an electronic device associated with the person or the animal;
obtaining GPS information of the robot; and
determining the distance between the robot and the person or the animal using the GPS information of the electronic device and the GPS information of the robot.

4. The method of claim 1, wherein determining the distance between the robot and the person or the animal includes:
emitting an ultrasonic wave toward the person or the animal; and
receiving a reflection of the ultrasonic wave from the person or the animal.

5. The method of claim 1, wherein determining the distance between the robot and the person or the animal includes:
emitting a radio-frequency (RF) signal; and
detecting a reflection of the RF signal from the person or the animal.

6. The method of claim 1, wherein determining the distance between the robot and the person or the animal includes:
capturing an image of the person or the animal;
analyzing the image of the person or the animal; and
calculating the distance between the robot and the person or the animal based on a result of analyzing the image.

7. The method of claim 1, wherein rotating the cutting blade includes operating a motor driving the cutting blade in a first mode, and changing the rotational speed of the cutting blade includes operating the motor in a second mode, and
wherein the method further comprises:
redetermining the distance between the robot and the person or the animal after changing the rotational speed of the cutting blade; and
switching the motor from the second mode to the first mode when the redetermined distance between the robot and the person or the animal is a threshold value or more.

8. The method of claim 1, wherein the robot is a lawn mower robot for cutting grass.

9. The method of claim 3, wherein the electronic device is carried by the person.

10. The method of claim 3, wherein the electronic device is worn by the animal.

11. A robot configured to move in a space, the robot comprising:
a wheel that is rotated to move the robot;
a cutter;
a motor configured to rotate the cutter;
a sensor configured to collect sensor data related to a person or animal in an area where the robot is moving; and
a processor configured to:
determine a distance between the robot and the person or the animal based on the sensor data, and
control operation of the motor based on the distance between the robot and the person or the animal.

12. The robot of claim 11, wherein the processor, when controlling the operation of the motor, is configured to stop the motor when the distance between the robot and the person or the animal is within a threshold value.

13. The robot of claim 11, further comprising:
a transceiver configured to receive global positioning system (GPS) information of an electronic device associated with the person or the animal,
wherein the sensor is configured to detect GPS information of the robot, and
wherein the processor determines the distance between the robot and the person or the animal using the GPS information of the electronic device and the GPS information of the robot.

14. The robot of claim 11, further comprising:
an emitter configured to output an ultrasonic wave,
wherein the sensor is configured to detect a reflection of the ultrasonic wave from the person or the animal, and
wherein the processor determines the distance between the robot and the person or the animal based on the ultrasonic wave and the reflection of the ultrasonic wave.

15. The robot of claim 11, further comprising:
an emitter configured to output a radio frequency (RF) signal,
wherein the sensor is configured to detect a reflection of the RF signal from the person or the animal, and
wherein the processor determines the distance between the robot and the person or the animal using the RF signal and the reflection of the RF signal.

16. The robot of claim 11,
wherein the sensor captures an image of the person or the animal, and
wherein the processor analyzes the image, and calculates the distance between the robot and the person or the animal based on a result of analyzing the image.

17. The robot of claim 11, wherein the processor:
controls the motor to switch from operating in a first mode to a second mode when the distance between the robot and the person or the animal is within a threshold value,
updates the distance between the robot and the person or the animal while the motor is operating in the second mode, and
controls the motor to switch from operating in the second mode to operating in the first mode when the updated distance between the robot and the person or the animal is the threshold value or more.

18. The robot of claim 12, wherein the robot continues to move while the motor is stopped.

19. The robot of claim 13, wherein the electronic device is carried by the person.

20. The robot of claim 13, wherein the electronic device is worn by the animal.
